(19) United States
(12) Patent Application Publication
(10) Pub. No.: US 2018/0069685 A1
(43) Pub. Date: Mar. 8, 2018

(54) Dynamic TDD Design, Methods And Apparatus Thereof

(71) Applicant: MediaTek Inc., Hsinchu City (TW)

(72) Inventors: Weidong Yang, San Diego, CA (US); Yu-Chuan Lin, New Taipei City (TW); Chien-Hwa Hwang, Hsinchu County (TW); Bo-Si Chen, Keelung City (TW); Pei-Kai Liao, Nantou County (TW); Yih-Shen Chen, Hsinchu County (TW)

(21) Appl. No.: 15/698,594

(22) Filed: Sep. 7, 2017

Related U.S. Application Data
(60) Provisional application No. 62/384,210, filed on Sep. 7, 2016.

(51) Int. Cl. H04L 5/14; H04W 72/04; H04W 52/34

(52) U.S. Cl. CPC H04L 5/14; H04W 52/34; H04W 72/0446

(57) ABSTRACT

Concepts and examples pertaining to dynamic time division duplex (TDD) in wireless communication systems are described. A first node of a wireless network of a plurality of nodes exchanges coordination information, which is related to transmissions of the nodes of the wireless network using TDD, with at least a second node of the wireless network. The first node performs wireless communications with at least the second node based on the exchanged coordination information.

### CROSS REFERENCE TO RELATED PATENT APPLICATION(S)

The present disclosure claims the priority benefit of U.S. Provisional Patent Application No. 62/384,210, filed 7 Sep. 2016, the content of which is incorporated by reference in its entirety.

### TECHNICAL FIELD

The present disclosure is generally related to wireless communications and, more particularly, to dynamic time division duplex (TDD) in wireless communication systems.

### BACKGROUND

Unless otherwise indicated herein, approaches described in this section are not prior art to the claims listed below and are not admitted as prior art by inclusion in this section.

In a 5^{th} Generation (5G) New Radio (NR) wireless communication system, the use cases of enhanced mobile broadband (eMBB) and ultra-reliable, low-latency communications (URLLC) are driving the NR design towards small schedulable units in the time domain. Under eMBB, latency and high throughput (to avoid intermediate buffering) are two drivers for small schedulable units. Small schedulable units lead to higher requirements on inter-cell/inter-link coordination, such as from a base station (BS) to a user equipment (UE), from a UE to another UE, and from a UE to a BS. Toward those ends, the design goals include the capabilities of traffic adaptation and forward compatibility as well as flexible duplex. There are two aspects with respect to traffic adaptation and forward compatibility, namely time division duplex (TDD) and frequency division duplex (FDD). For TDD (including conventional TDD spectrum and millimeter wave (mmWave) spectrum), the design goal includes downlink (DL) and uplink (UL) in TDD spectrum with dynamic use of resources for DL and UL. For FDD, the design goal includes DL/UL in DL spectrum of FDD with dynamic use of resources for DL and UL (for traffic adaptation), and the design goal also includes DL/UL in UL spectrum of FDD with dynamic use of resources for DL and UL. With respect to flexible duplex, flexible duplex is identified as a possible way to utilize conventional TDD/FDD spectrum with a unified air interface.

As transmission direction in a cell can be adjusted on a slot-by-slot basis, the so-called “dynamic TDD” is enabled. When different cells decide to use slots for DL or UL depending on the local needs, e.g., adaptation to uplink/downlink traffic, at a given slot different cells may not have aligned transmission direction. Consequently, a UE and/or an eNB/gNB/TRP can suffer from cross-link interference.

Dynamic TDD includes full duplex and quasi-full duplex. In a full duplex scenario, two nodes can transmit signals to each other and receive signals from each other at the same time. In a quasi-full duplex scenario, a BS can transmit signals to one UE and at the same time receive signals from another UE. Quasi-full duplex tends to be easier than full duplex to implement if dynamic TDD and advanced receiver technology are used. However, there are some challenges in dynamic TDD. For instance, eNB-eNB interference is identified as a severe problem in dynamic TDD. Moreover, UE-UE interference is also identified as an issue in dynamic TDD. Exchange of scheduling information among nodes due to non-ideal backhaul and critical timing arising from small schedulable units in 5G is another challenge.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, concepts and examples to address aforementioned issues with respect to dynamic TDD.

In one aspect, a method may involve a first node of a wireless network of a plurality of nodes exchanging coordination information, which is related to transmissions of the nodes of the wireless network using TDD, with at least a second node of the wireless network. The method may also involve the first node performing wireless communications with at least the second node based on the exchanged coordination information.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scheme of coordination between cells using subframes in accordance with an implementation of the present disclosure.

FIG. 2 is a diagram of an example scheme of mutually hearable patterns in accordance with an implementation of the present disclosure.

FIG. 3 is a diagram of an example design of mutually hearable pattern for information exchange in accordance with an implementation of the present disclosure.

FIG. 4 is a diagram of an example of channel state information (CSI) measurement in accordance with an implementation of the present disclosure.

FIG. 5 is a diagram of an example of CSI measurement in accordance with an implementation of the present disclosure.

FIG. 6 is a diagram of an example scenario of self-organized clustering in accordance with an implementation of the present disclosure.

FIG. 7 is a diagram of an example system in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under proposed schemes in accordance with the present disclosure, exchange of coordination information may occur among nodes in a network. Each node in the network may be a BS or a UE, and a UE may be engaged in communication with a BS, another UE, or both, at a given time. Thus, the exchange of coordination information may take place in three types of node pairs: BS-BS, BS-UE and UE-UE. Herein, a BS may be an eNB in an LTE-based network of a gNB in a 5G/NR network.

A system design for dynamic TDD in accordance with the present disclosure may utilize a number of design features to provide improvements over the interference mitigation schemes proposed for enhanced Interference Mitigation and Traffic Adaptation (eIMTA) in LTE-based networks. Such improvements include at least the following aspects: asynchronous hybrid automatic repeat request (HARQ) for both DL and UL, faster channel state information (CSI) measurements and reporting, and efficient control channel design with native support for HARQ-acknowledgements (HARQ-ACK) and CSI feedbacks from multiple subframes and multi-carriers. Each subframe may be considered a time unit or time interval. The proposed schemes also support both centralized coordination and distributed control and coordination.

A system design for dynamic TDD in accordance with the present disclosure may take features from eIMTA with important differences. One difference from eIMTA relates to the aspect of aligned subframes versus flexible subframes. Under the proposed schemes in accordance with the present disclosure, coordination among picocells may be helpful in mitigating interference. Another difference from eIMTA relates to the aspect of dual power control. Under the proposed schemes in accordance with the present disclosure, the selection of a power control parameter set may be indicated dynamically in a downlink control information (DCI) for UL grant/UL scheduling. That is, signaling of power control in the control channel may be utilized so that the power control parameter set may be dynamically indicated. A further difference from eIMTA relates to the aspect of dual CSI feedback. Under the proposed schemes in accordance with the present disclosure, CSI resources may be aperiodic.

A system design for dynamic TDD in accordance with the present disclosure may also include fundamental differences from eIMTA. For instance, in the system design according to the present disclosure, there may be no DL/UL definition, and the effective DL/UL configurations used in field deployment may be set through operations, administration and management (OAM) or over the air sniffing. Product differentiation and forward compatibility may be supported. Additionally, in the system design according to the present disclosure, there may be no complicated fixed TDD timing definitions for HARQ and physical uplink shared channel (PUSCH) transmissions. Rather, flexible HARQ/PUSCH timing may be allowed. Acknowledgement (ACK) design may be blocked so that complicated ACK multiplexing rules may be avoided. Native support for multi-subframe and multi-carrier HARQ-ACK and CSI feedback may be provided. Moreover, in the system design according to the present disclosure, multi-subframe scheduling as in enhanced Licensed Assisted Access (eLAA) (which only supports UL scheduling) to handle different desired DL/UL traffic split may be supported. That is, scheduling of multiple slots/subframes for both DL and UL may be supported. Furthermore, over the air Layer 1 (L1) signaling/physical signaling scheme to facilitate coordination between DL/DL, UL/UL and DL/UL for just-in-time transmission decision may be supported.

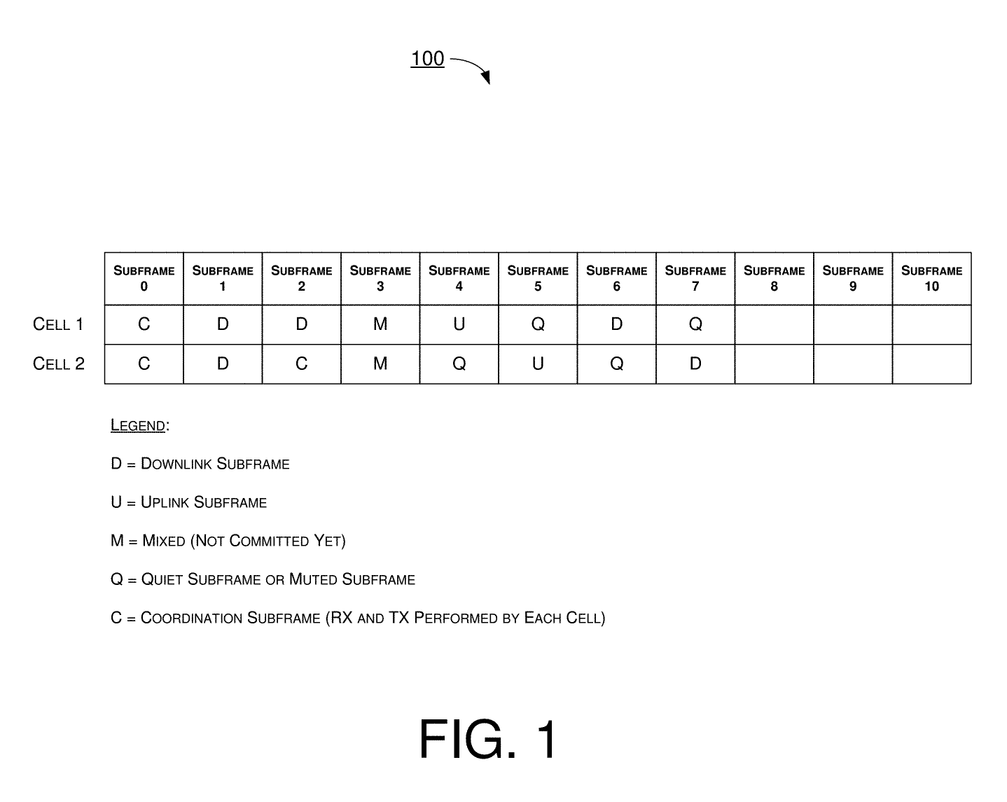

FIG. 1 illustrates an example scheme 100 of coordination between cells using subframes in accordance with an implementation of the present disclosure. Under scheme 100, coordination between cells may be conducted asynchronously such as, for example and without limitation, by using a preamble or header in a subframe (e.g., similar to network allocation vector (NAV) in Wi-Fi). Alternatively or additionally, coordination between cells may be conducted synchronously or quasi-periodically such as, for example and without limitation, by using a coordination subframe. It is noteworthy that, although the example shown in FIG. 1 depicts exchange of coordination information between two cells, namely Cell 1 and Cell 2, scheme 100 may be implemented with and by more than two cells in a network. Thus, the scope of scheme 100 is not limited to what is shown in FIG. 1.

Referring to FIG. 1, under scheme 100, there may be different types of subframes, which may be equivalent to time intervals, such as type “D” subframes, type “U” subframes, type “M” subframes, type “0” subframes, and type “C” subframes (hereinafter interchangeably referred as “D” subframes, “U” subframes, “M” subframes, “Q” subframes and “C” subframes, respectively). Type “D” subframes may be downlink subframes, over which eNBs/gNBs/TRPs in a LTE-based network (or Transmission and Reception Points (TRPs) in a NR network) in a cluster or a coordination area may perform transmission while some or all UEs under their control may perform reception. Type “U” subframes may be uplink subframes, over which UEs in a cluster or a coordination area may perform transmission while the eNBs/gNBs/TRPs/TRPs in the cluster or coordination area may perform reception. Type “Q” subframes may be quiet or muted subframes, over which an eNB/gNB/TRP/TRP and UEs under its control may desist from transmitting any signals to avoid interference on other BS and/or UE nodes. Type “C” subframes may be coordination subframes, the reception (RX) and transmission (TX) of which may be performed by each cell. Type “M” subframes may be mixed, hybrid or otherwise flexible subframes. For instance, an “M” subframe may be a hybrid or composite subframe containing multiple subframes of other types, such as one or more “D” subframes, one or more “U” subframes and/or one or more “Q” subframes. In contrast, type “D”, “U” and/or “Q” subframes may be fully committed.

During a type “C” (coordination) subframe, scheduling information for the next X number of subframes may be announced. When two eNBs/gNBs/TRPs make announcements at the same time, they may not be able to hear each other. It is noteworthy that, when side links (e.g., device-to-device (D2D) communication standard in LTE-A networks, vehicle-to-vehicle (V2V) standard, and the like) are considered, a node with a UE personality may also transmit on the coordination subframe.

Under scheme 100, an interface may be composed by defining a frame structure/subframe design through combining some or all of the defined subframes such as “U”, “D”, “M”, “Q” and “C” subframes. As an example, a time unit in the frame structure of the air interface may start with a “D” subframe and may contain “U”, “M”, “Q” and/or “C” subframes depending on the signaling provided in the “D” subframe. As another example, a “C” subframe may be used for multipoint-multipoint information exchange and control, and may be combined with the control portion of a “D” subframe, which may be used for single point-to-multiple point information exchange and control. It is noteworthy that different subframes, such as “D”, “U”, “M”, “Q” and “C” subframes, do not necessarily have the same duration at all times. Although the example shown in FIG. 1 may depict each type of subframes to be of equal length in duration, the subframes may have different lengths in duration. Advantageously, this allows the flexibility in constructing different slot types with the different types of subframes, and the control signaling provided in “D” subframes may indicate the “slot type.”

In the example shown in FIG. 1, during subframe 0 (or time unit 0), Cell 1 and Cell 2 exchange coordination information using “C” subframes. During subframe 1 (or time unit 1), both Cell 1 and Cell 2 perform downlink transmission and/or reception. During subframe 2 (or time unit 2), Cell 1 performs downlink transmission and/or reception, and Cell 2 exchanges coordination information (e.g., with another cell). During subframe 3 (or time unit 3), both Cell 1 and Cell 2 perform transmission and/or reception, or remain quiet for some time, as subframe 3 is an “M” subframe. During subframe 4 (or time unit 4), Cell 1 performs uplink transmission and/or reception, and Cell 2 remains quiet. During subframe 5 (or time unit 5), Cell 1 remains quiet, and Cell 2 performs uplink transmission and/or reception. During subframe 6 (or time unit 6), Cell 1 performs downlink transmission and/or reception, and Cell 2 remains quiet. During subframe 7 (or time unit 7), Cell 1 remains quiet, and Cell 2 performs downlink transmission and/or reception.

It is noteworthy that, although the duration or length of each subframe depicted in FIG. 1 may appear to be constant, in various implementations in accordance with the present disclosure the duration of subframes may be constant or, alternatively, variable (e.g., adjusted to be longer or shorter) depending on the need. It is also noteworthy that, although subframe N for Cell 1 appears to be aligned with subframe N for Cell 2 (with N being 0 or a positive integer) as shown in FIG. 1, this does not mean the starting time and/or ending time of subframe N for Cell 1 is necessarily aligned temporally with the starting time and/or ending time of subframe N for Cell 2.

### Distributed Information Exchange

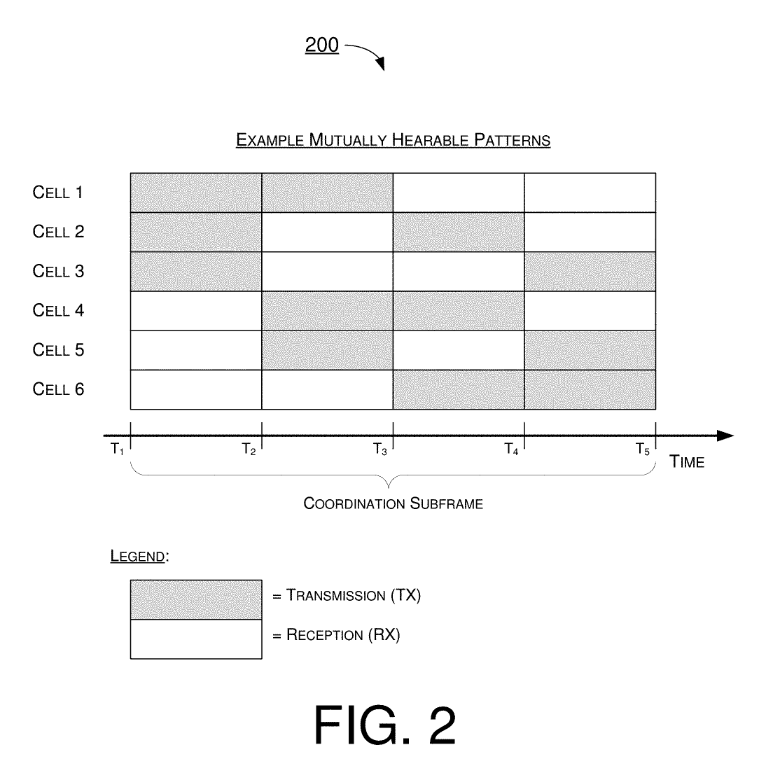

FIG. 2 illustrates an example scheme 200 of mutually hearable patterns in accordance with an implementation of the present disclosure. Scheme 200 may be an example of mutually hearable patterns for over the air sniffing. Under scheme 200, coordination subframes (e.g., “C” subframes) may be co-located with discovery reference signal (DRS) subframes to provide coordination information on a long-term basis in addition to that on a short-term basis. In general, coordination subframes may be transmitted at time intervals other than those for DRS subframes.

Referring to FIG. 2, scheme 200 may provide an example of transmission (TX) and reception (RX) patterns of how over the air sniffing for six cells may be conducted, without considering radio frequency (RF) switching between TX and RX at each cell. Sniffing by UEs may be possible, and transmission during coordination subframes from UEs (e.g., regular UEs or D2D/V2V UEs) to provide coordination information may also be possible. By utilizing the coordination subframe, cellular DL, cellular UL, backhaul link as well as D2D link may all coordinate their transmissions and usages. For UEs under the control of a BS (e.g., eNB, gNB or TRP), the BS may dynamically signal coordination information to the UEs under control. Thus, scheme 200 provides a unified solution for different link types (e.g., access links, D2D links, backhaul links), and hence the examples provided herein are not limited to implementations in or by eNBs/gNBs/TRPs. Accordingly, the example shown in FIG. 2 provides mutually hearable patterns to facilitate information exchange among eNBs/gNBs/TRPs.

Under scheme 200, during a single coordination subframe, each cell may have multiple opportunities for transmission (e.g., for sharing information) as well as multiple opportunities for reception (e.g., for receiving information). The mutually hearable pattern design for D2D communications may be utilized to exchange information among cells/nodes.

In the example shown in FIG. 2, between time T1 and time T2, each of Cell 1, Cell 2 and Cell 3 transmits coordination information while each of Cell 4, Cell 5 and Cell 6 listens to or receives the coordination information from Cell 1, Cell 2 and Cell 3. Between time T2 and time T3, each of Cell 1, Cell 4 and Cell 5 transmits coordination information while each of Cell 2, Cell 3 and Cell 6 listens to or receives the coordination information from Cell 1, Cell 4 and Cell 5. Between time T3 and time T4, each of Cell 2, Cell 4 and Cell 6 transmits coordination information while each of Cell 1, Cell 3 and Cell 5 listens to or receives the coordination information from Cell 2, Cell 4 and Cell 6. Between time T4 and time T5, each of Cell 3, Cell 5 and Cell 6 transmits coordination information while each of Cell 1, Cell 2 and Cell 4 listens to or receives the coordination information from Cell 3, Cell 5 and Cell 6.

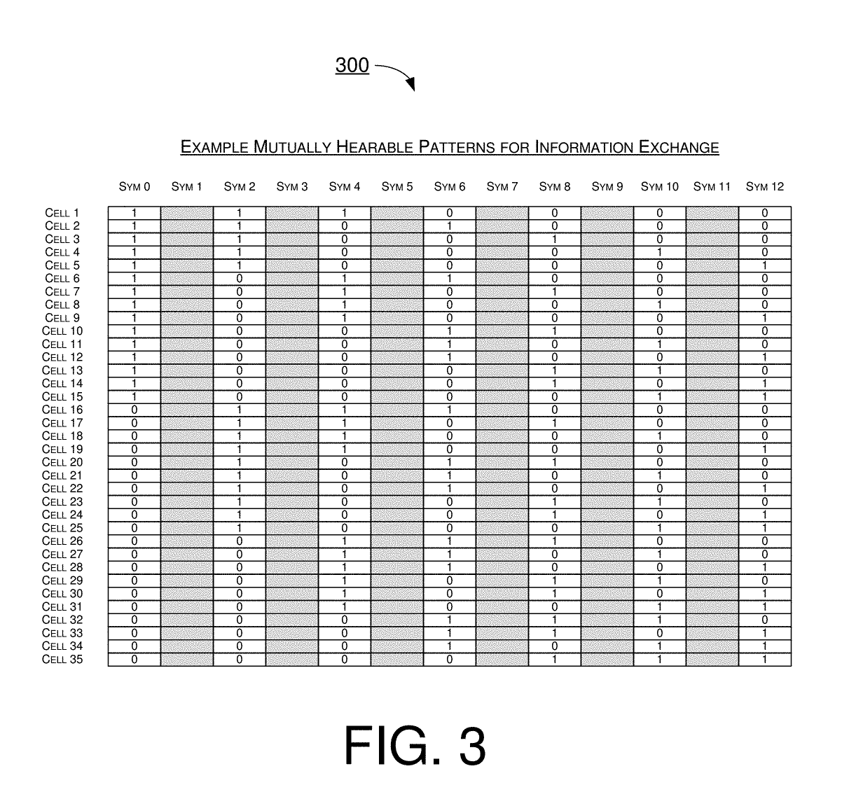

FIG. 3 illustrates an example design 300 of mutually hearable pattern for information exchange in accordance with an implementation of the present disclosure. In design 300, a 60 KHz carrier spacing is assumed, and a duration of a coordination subframe is 250 μs. Moreover, a symbol duration is 16.67 μs, and there are twelve to fourteen symbols per subframe. In design 300, “1” is for transmission and “0” is for reception for symbols of even indices, and symbols of odd indices are used for RF switching. As an example, for nchoosek(14/2, 3)=35, at most 35 cells may engage in information exchange. Design 300 may also be seen as an example for both L1 signaling and physical signal transmission in coordination time intervals.

### CSI Measurement in Dynamic TDD

Depending on whether a CSI measurement is made for “D” subframes or “M” subframes, the CSI measurement procedure/setup may be different, considering transmission power at BS and averaging of interference. For instance, assumption for transmission power for a BS may be different depending on whether it is “D” subframes or “M” subframes.

Under the proposed scheme, a UE may report two CSIs. A first CSI may be for the case that all the top interfering cells are aligned with the serving cell of the UE. This may be treated as a motivation rather than a hard requirement, and it is possible that a second-strongest cell may not be aligned with its serving cell. This may be for “D” subframes. A second CSI may be for the case that some of the top interfering cells are not aligned with the serving cell of the UE. This may be for “M” subframes. The first CSI may be for a somewhat coordinated scenario with mitigated interference. The second CSI may be for a scenario with un-mitigated interference.

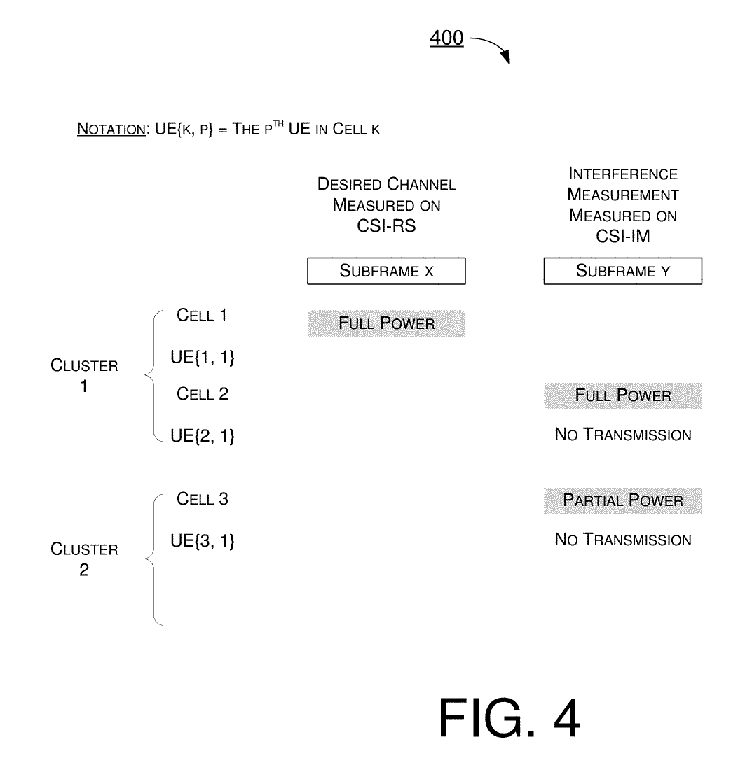

FIG. 4 illustrates an example 400 of CSI measurement for channel response and interference on “D” subframes in accordance with another implementation of the present disclosure. In the example shown in FIG. 4, UE{1, 1} (which is the 1^{st} UE in Cell 1) under Cell 1 performs CSI measurement on “D” subframes. In this example, Cell 1 and Cell 2 are in the same cluster (denoted as “Cluster 1” in FIG. 4), and Cell 3 is in a different cluster (denoted as “Cluster 2” in FIG. 4). In the example shown in FIG. 4, during subframe Y for interference measurement, Cell 2 may transmit in full power while there is no transmission from UE{2, 1}, and Cell 3 may transmit in partial power while there is no transmission from UE{3, 1}. Cell 1 uses full power density over the CSI-reference signal (CSI-RS) resource in a “D” subframe. Interference measurement for CSI (CSI-IM) of UE{1, 1} is dominated by interference within the cluster. Interference over multiple subframes may be relatively stable, and a small number of “D” subframes may provide sufficient information. Thus, interference measurement over one or multiple “D” subframes may provide accurate interference estimate for CSI reporting.

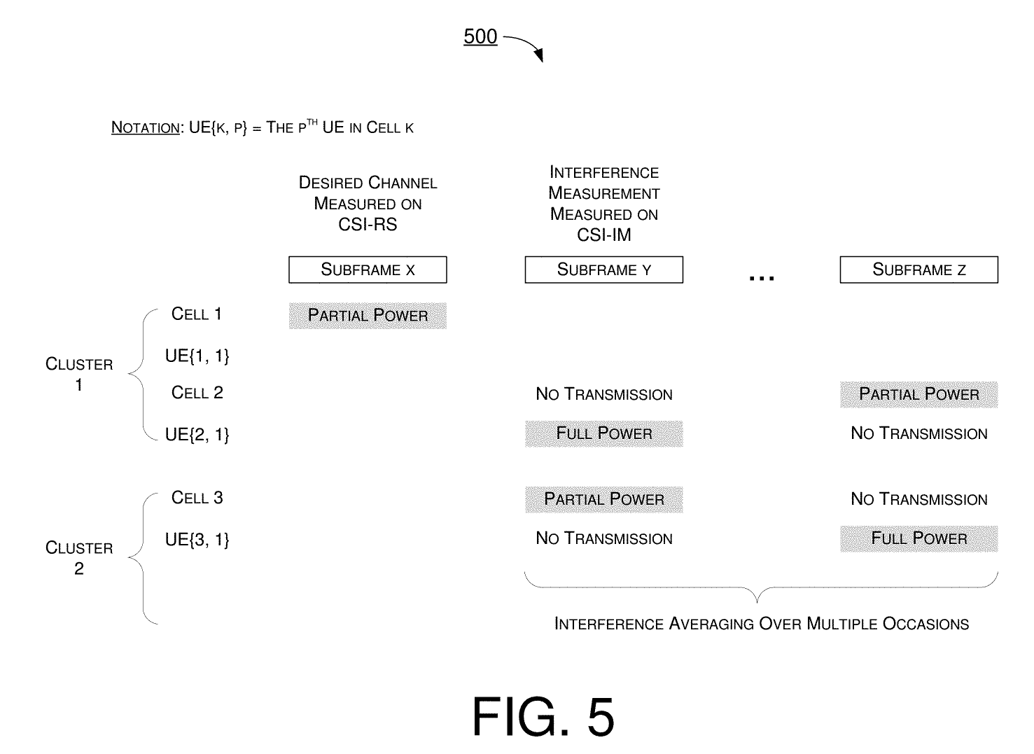

FIG. 5 illustrates an example 500 of CSI measurement for channel response and interference on “M” subframes in accordance with an implementation of the present disclosure. In the example shown in FIG. 5, partial power is used for Cell 1 during an “M” subframe. In this example, Cell 1 and Cell 2 are in the same cluster (denoted as “Cluster 1” in FIG. 5), and Cell 3 is in a different cluster (denoted as “Cluster 2” in FIG. 5). As Cell 1 uses reduced power density over an “M” subframe, the measured channel quality indicator (CQI) for UE{1, 1} is likely to be lower than that over a “D” subframe. Also, the interference during an “M” subframe can change rather dynamically. An average over multiple “M” subframes may be necessary to obtain reliable interference estimate for CSI reporting. Moreover, different interference averaging setups for “M” and “D” subframes may be helpful and may address different needs. In the example shown in FIG. 5, during subframe Y for interference measurement, UE{2, 1} may transmit in full power while there is no transmission from Cell 2, and Cell 3 may transmit in partial power while there is no transmission from UE{3, 1}. Moreover, during subframe Z, Cell 2 may transmit in partial power while there is no transmission from UE{2, 1}, and UE{3, 1} may transmit in full power while there is no transmission from Cell 3.

### Power Control in Dynamic TDD

According to the present disclosure, there may be multiple power control schemes with flexible utilization of subframes. Under a baseline scheme (or “semi-static scheme”), an eNB/gNB/TRP may reduce its downlink power during “M” subframes. Additionally, UEs may boost up their TX power during “M” subframes. Under an improved scheme (or “first dynamic scheme”), the exact amount in the reduction of TX power of an eNB/gNB/TRP may be a function of coupling losses among nodes, including eNBs/gNBs/TRPs and UEs. Moreover, the exact amount in boost of UE power may be a function of coupling losses among nodes, including eNBs/gNBs/TRPs and UEs. Under another improved scheme (or “second dynamic scheme”), an eNB/gNB/TRP may reduce its DL power during “M” subframes. Additionally, UEs may boost up their TX power during “M” subframes. Moreover, desired traffic split and experienced traffic split may be compared and implemented. In some cases, a combination of one or more of aforementioned power control schemes may be implemented simultaneously.

The following is a description of analysis on power control on “M” subframes.

To simplify a receive model, it is assumed that at any given subframe at most one UE is scheduled in uplink at each cell, and at most one UE is scheduled in downlink at each cell. In the analysis, there are two cells of interest, namely Cell i₁ and Cell i₂. Cell i₁ performs UL reception, and the transmitting UE is denoted as U(i₁). Cell i₂ performs DL transmission, and the intended UE is denoted as D(i₂). The path loss between nodes (eNB/gNB/TRP or UE) is denoted as L_{i,j}. The full TX power at an eNB/gNB/TRP is denoted as P_{α}, and β is a factor of reduction in the eNB/gNB/TRP TX power. It is assumed that fractional power control is used for uplink: (α, P₀), assuming full bandwidth assignment so P₀ absorbs the bandwidth dependent term. The receive model for uplink is given by all cells such as Cell i′ performing DL transmission with intended UE D(i′), Cell i″ performing UL reception with transmit UE U(i″).

The uplink signal-to-interference-plus-noise ratio (SINR) at Cell i₁ is given by the following expressions:

Desired signal −(1−α)L_{i1,U(i1)}+P₀

Uplink interference −L_{i1,U(i″)}+αL_{i″,U(i″)}+P₀

Downlink interference −L_{i1,i′}+(β+Pₜₓ)

Noise noise figure+thermal noise

The downlink SINR at D(i₂) is given by the following expressions:

Desired signal −L_{i2,D(i2)}+(β+Pₜₓ)

Uplink interference −L_{D(i2),U(i″)}+αL_{i″,U(i″)}+P₀

Downlink interference −L_{i′,D(i2)}+(β+Pₜₓ)

Noise noise figure+thermal noise

Assume uplink SINR is dominated by downlink interference from eNB/gNB/TRP i′, and the downlink SINR at D(i₂) is dominated by uplink interference from U(i″), then the following expressions may be obtained:

Uplink SINR −(1−α)L_{i1,U(i1)}+L_{i1,I′}−β−Pₜₓ+P₀

Downlink SINR −L_{i2,D(i2)}+L_{D(i2),U(i″)-}αL_{i″,U(i″)}−(−β−Pₜₓ+P₀)

Subject to L_{i,U(i)}+P₀≦Pₘₐₓ

Here, β+Pₜₓ controls the eNB/gNB/TRP power. When β=0, full power is used. Moreover, P₀ controls TX power of UE. From the approximates to downlink SINR and uplink SINR, it can be seen that P₀ and β can be used to trade between uplink throughput and downlink throughput. When −β−Pₜₓ+P is fixed, different combinations of {β, P₀} may be chosen, but such a tradeoff is of a secondary importance. Given a fixed {β, P₀}, increasing a may improve uplink SINR and reduce downlink SINR. Hence, a may be another factor to tune. It is noteworthy that a may not be as straightforward as its impact to uplink/downlink SINRs depending on the coupling losses.

### Base Station Scheduling in Dynamic TDD

The present disclosure provides a number of eNB/gNB/TRP scheduling schemes for different types of subframes. For DL transmission on a “D” subframe, for each candidate UE, the CSI from “D” subframes may be used in the calculation of its proportional fair (PF) metric. Full power may be used in the transmission to the selected UE(s). For UL transmission on an “U” subframe, for each candidate UE, the power control rule for “U” subframes may be used. Alternatively, a regular power rule may be used. As an example, with the fractional power control rule as in LTE, α and P₀ may be chosen for tradeoff between average throughput and 5-percentile throughput.

With respect to eNB/gNB/TRP scheduling for “M” subframes, an eNB/gNB/TRP may first need to decide whether an “M” subframe should be used for DL or UL. This may be decided based on a comparison of the experienced DL/UL traffic split (e.g., 3 MB/2 MB) to the desired DL/UL traffic split (e.g., 4 MB/2 MB), and a transmission direction may be chosen to close the gap between the experienced and desired DL/UL traffic splits toward the desired DL/UL traffic split. For example, when UL is underserved, the “M” subframe may be used for UL. In the present disclosure, experienced DL/UL traffic split may be related to historical averaging of served DL and UL traffics. The averaging may be done using an arithmetic and geometric method, moving average, or a combination thereof.

For DL transmission on an “M” subframe, for each candidate UE, the CSI from “M” subframes may be used in the calculation of the PF metric thereof. Partial power may be used in the transmission(s) to the selected UE(s). In some implementations, cell-center UEs may be favored over cell-edge UEs as the CQIs of the cell-center UEs in “M” subframes tend to suffer less degradation compared to those from “D” subframes. For UL transmission on an “M” subframe, for each candidate UE, the power control rule for “M” subframes may be used. Specifically, the targeted power level may be higher. In some implementations, cell-center UEs may be favored as they are less likely to hit the power limit.

An alternative method for determining the transmission direction on an “M” subframe is also provided. According to the present disclosure, a metric similar to the PF metric to capture both DL and UL may be defined so that a systematic way to decide DL and UL/DL may be identified. For example, even if UL is underserved, if using the “M” subframe for UL would not carry much data, then the “M” subframe may be used for DL transmissions. As an example, a BS may examine two values: (1) CQI_{UL}/{aggregate cell UL traffic amount}×scaling factor; and (2) CQI_{DL}/{aggregate cell DL traffic amount}. The scaling factor captures the difference in average spectrum efficiency in DL and UL, as a function of desired DL/UL traffic split and experienced DL/UL traffic split. If currently UL is underserved, then the scaling factor is large; otherwise the scaling factor is small. Here, CQI_{UL} is the UL CQI for the winner UE(s) from the uplink PF scheduler. Moreover, CQI_{DL} is the DL CQI for the winner UE(s) from the downlink PF scheduler.

### Clustering in Dynamic TDD

If and when the cells are clustered by an operator in any of the above-described schemes, it would require a substantial amount of work. It would also be recurrent work if a new node is to be added to a network. Accordingly, the present disclosure provides a self-organized clustering scheme. By leveraging the coordination subframes (e.g., “C” subframes), a self-organized clustering may be possible. For instance, an eNB/gNB/TRP may receive information from the “C” subframes, and may use a threshold to determine what cells are in its own cluster. This may be an individual cell-centric clustering, and each cell may have different clustering. Information included in the broadcast information of each eNB/gNB/TRP may include information on the cells in its cluster, as well as the desired DL/UL traffic split and experienced DL/UL traffic split. An eNB/gNB/TRP may adjust its power control parameters (e.g., β and P₀) according to aggregated desired/experienced DL/UL traffic splits from cells which list that eNB/gNB/TRP in their clustering information.

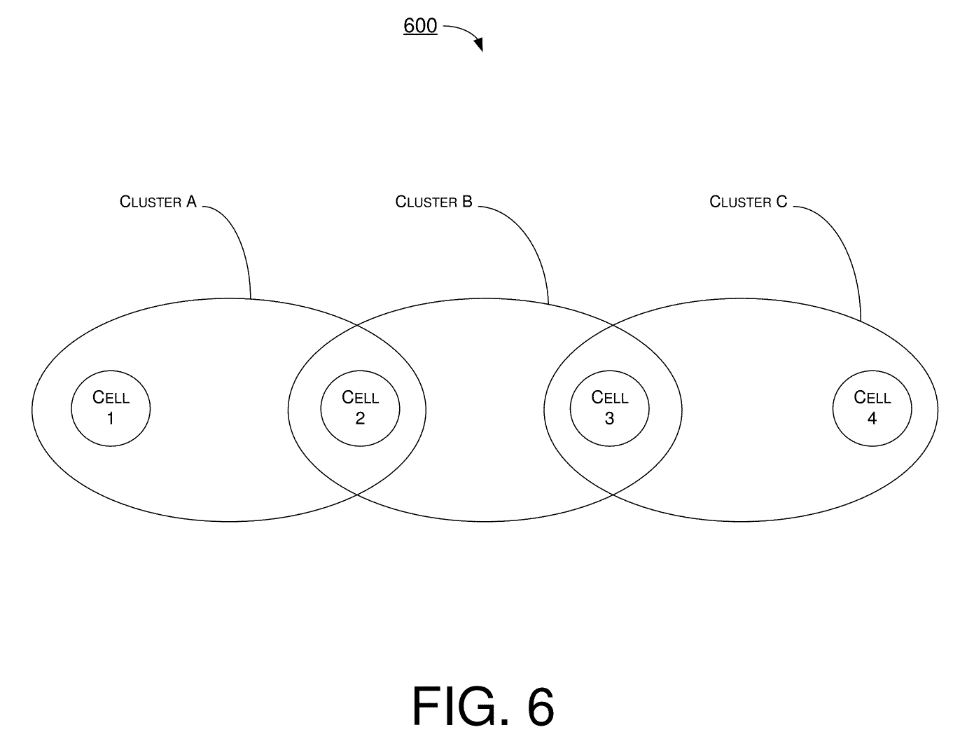

FIG. 6 illustrates an example scenario 600 of self-organized clustering in accordance with an implementation of the present disclosure. In scenario 600, Cell 1 may list cells {1, 2} in its own cluster (labeled as “Cluster A” in FIG. 6), Cell 2 may list cells {2, 3} in its own cluster (labeled as “Cluster B” in FIG. 6), and Cell 3 may list cells {3, 4} in its own cluster (labeled as “Cluster C” in FIG. 6). The clustering information for each cell may be broadcast in coordination subframes (e.g., “C” subframes). Cell 1 may collect desired/experienced DL/UL traffic splits from cells {1, 2}. Cell 2 may collect desired/experienced DL/UL traffic splits from cells {1, 2, 3}. Cell 3 may collect desired/experienced DL/UL traffic splits from cells {2, 3, 4}.

### Cell Coordination and Power Control

With respect to cell coordination, an operation may configure cells into clusters by, for example and without limitation, drive test in real deployment, simulation cell clustering algorithm as in eIMTA, or both. Then, the coordination period may be set (similar to the 10 ms radio frame of TDD). Each cell may broadcast its desired UL and DL traffic loading split. Each cell may also broadcast its experienced UL and DL traffic loading split. The desired UL and DL traffic loading may be found from the DL/UL data buffer sizes. Coordination subframes (e.g., “C” subframes) may be used for information exchange among cells. In terms of coordination, for “D” subframes, the following expression may be used: max(1, round(coordination period×minimum DL traffic percentage)). For “U” subframes, the following expression may be used: floor(coordination period×minimum UL traffic percentage). It is possible that the average UL spectrum efficiency may be different from its DL counterpart, and hence the above-listed expressions for “D” and “U” subframes may be improved. For example, each cell may broadcast its average UL spectrum efficiency and DL spectrum efficiency. The broadcast information may be taken into consideration by the cells in determining the numbers of “D” and “U” subframes.

Moreover, remaining time intervals/subframes in the coordination period may be used for “M” subframes. In some implementations, “Q” subframes may not be configured. Each cell may adopt a pattern of subframes (e.g., DDDMMMUUU), such that the cells in a given cluster may have consistent configurations. This way, scheduling delay for UL may also be handled. Additionally, power control for “D” and “U” subframes may be done as in LTE. As for power control for “M” subframes, the aggregated desired DL/UL traffic split may be compared to the aggregated experienced DL/UL traffic split. Under the proposed scheme, −β−Pₜₓ+P₀ may be decreased in an event that DL is underserved. Furthermore, −β−Pₜₓ+P₀ may be increased in an event that UL is underserved. It is noteworthy that aggregation of desired DL/UL traffic split as well as experienced DL/UL traffic split may be done using the same method or different methods, including arithmetic and geometric methods, for example. It is also noteworthy that information exchange among cells in a cluster may ensure that each cell in the cluster make the same adjustment so convergence to an optimal setting may be achieved.

### Illustrative Implementations

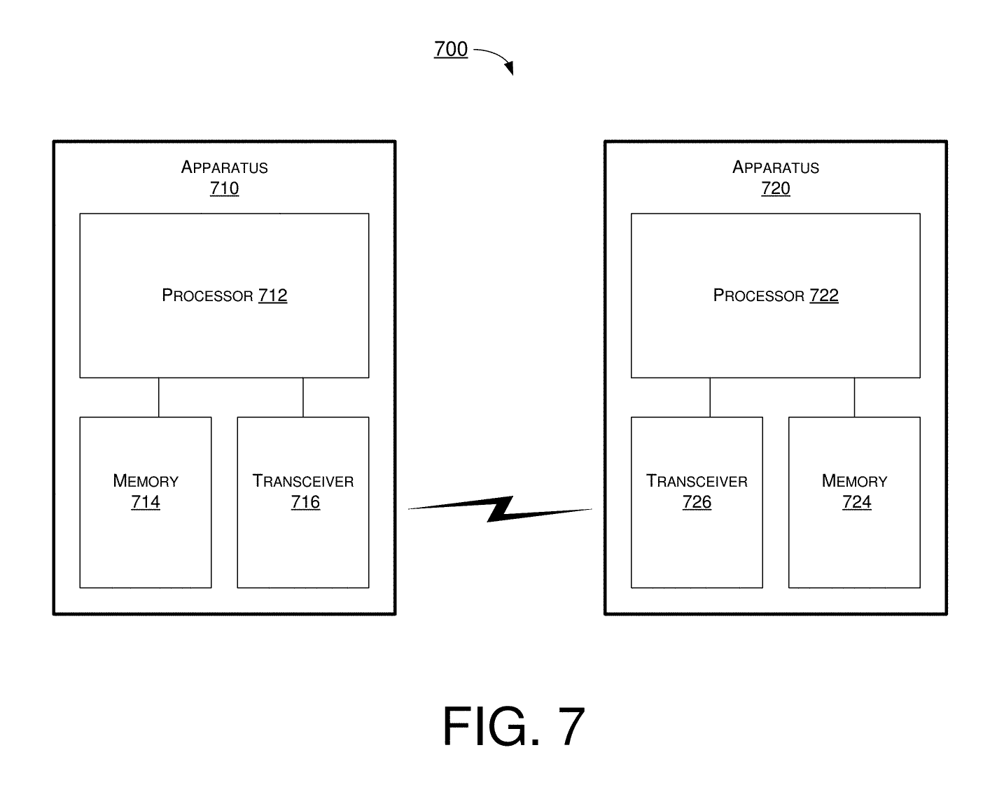

FIG. 7 illustrates an example system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to dynamic TDD in wireless communication systems, including the various schemes described above with respect to FIG. 1-FIG. 6 described above as well as process 800 described below.

Each of apparatus 710 and apparatus 720 may be a part of an electronic apparatus, which may be a BS or a UE, such as a portable or mobile apparatus, a wearable apparatus, a wireless communication apparatus or a computing apparatus. For instance, each of apparatus 710 and apparatus 720 may be implemented in a smartphone, a smartwatch, a personal digital assistant, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a wire communication apparatus or a computing apparatus. For instance, each of apparatus 710 and apparatus 720 may be implemented in a smart thermostat, a smart fridge, a smart door lock, a wireless speaker or a home control center. When implemented in or as a BS, apparatus 710 and/or apparatus 720 may be implemented in an eNodeB in a LTE, LTE-Advanced or LTE-Advanced Pro network or in a gNB or TRP in a 5G network, an NR network or an IoT network.

In some implementations, each of apparatus 710 and apparatus 720 may be implemented in the form of one or more integrated-circuit (IC) chips such as, for example and without limitation, one or more single-core processors, one or more multi-core processors, or one or more complex-instruction-set-computing (CISC) processors. In the various schemes described above with respect to FIG. 1-FIG. 6, each of apparatus 710 and apparatus 720 may be implemented in or as a BS or a UE. Each of apparatus 710 and apparatus 720 may include at least some of those components shown in FIG. 7 such as a processor 712 and a processor 720, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including those pertaining to dynamic TDD in wireless communication systems in accordance with various implementations of the present disclosure.

In some implementations, apparatus 710 may also include a transceiver 716 coupled to processor 712. Transceiver 716 may be capable of wirelessly transmitting and receiving data. In some implementations, apparatus 720 may also include a transceiver 726 coupled to processor 722. Transceiver 726 may include a transceiver capable of wirelessly transmitting and receiving data.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

In the interest of brevity and to avoid redundancy, detailed description of the capabilities of apparatus 710 and apparatus 720 is provided below with respect to process 800.

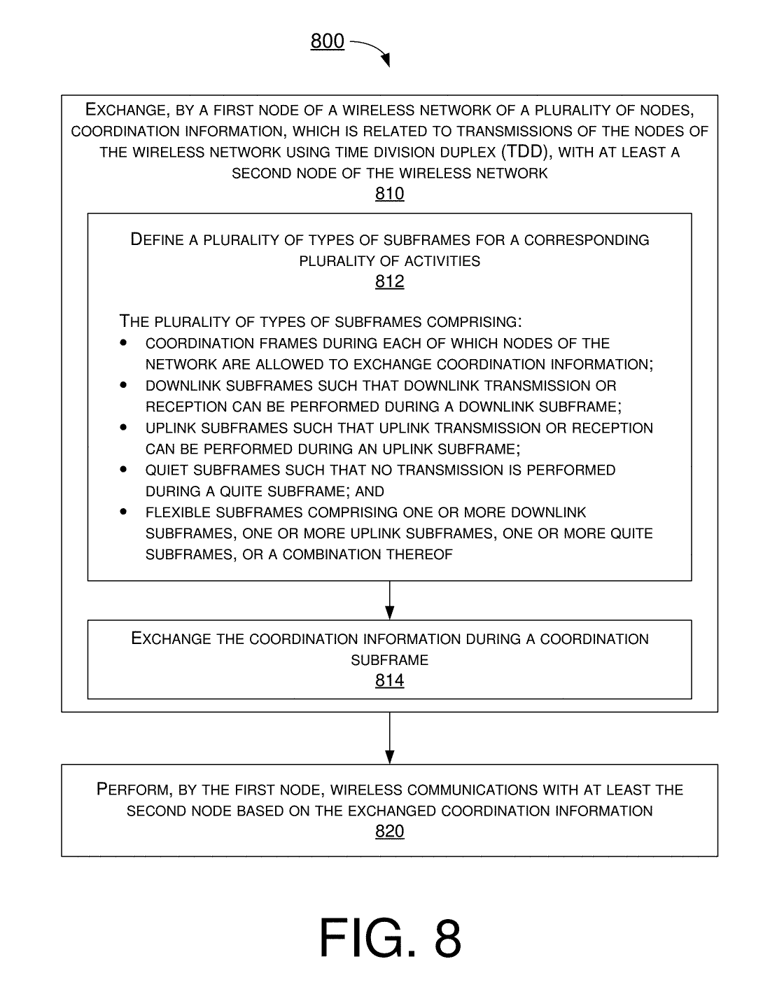

FIG. 8 illustrates an example process 800 in accordance with an implementation of the present disclosure. Process 800 may represent an aspect of implementing the proposed concepts and schemes such as one or more of the various schemes described above with respect to FIG. 1-FIG. 7. More specifically, process 800 may represent an aspect of the proposed concepts and schemes pertaining to dynamic TDD in wireless communication systems. For instance, process 800 may be an example implementation, whether partially or completely, of the proposed schemes described above for dynamic TDD in wireless communication systems. Process 800 may include one or more operations, actions, or functions as illustrated by one or more of blocks 810 and 820 as well as sub-blocks 812 and 814. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. The blocks/sub-blocks of process 800 may be executed iteratively. Process 800 may be implemented by or in apparatus 710 and/or apparatus 720 as well as any variations thereof. Solely for illustrative purposes and without limiting the scope, process 800 is described below in the context of apparatus 710 and apparatus 720. Process 800 may begin at block 810.

At 810, process 800 may involve processor 712 of apparatus 710, as a first node of a wireless network, exchanging coordination information, which is related to transmissions of the nodes of the wireless network using TDD, with apparatus 720 as a second node of the wireless network (e.g., via transceiver 716 and transceiver 726). Process 800 may proceed from 810 to 820.

At 820, process 800 may involve processor 712 performing wireless communications with at least the second node based on the exchanged coordination information.

In exchanging the coordination information, process 800 may involve processor 712 performing a number of operations as shown in sub-blocks 812 and 814.

At 812, process 800 may involve processor 712 defining a plurality of types of subframes for a corresponding plurality of activities. The plurality of types of subframes may include coordination frames (e.g., “C” subframes) during each of which nodes of the network are allowed to exchange coordination information. Process 800 may proceed from 812 to 814.

At 814, process 800 may involve processor 712 exchanging the coordination information with apparatus 720 (e.g., via transceiver 716 and transceiver 726) during a coordination subframe.

In some implementations, the plurality of types of subframes may further include the following: downlink subframes (e.g., “D” subframes) such that downlink transmission or reception can be performed during a downlink subframe; uplink subframes (e.g., “U” subframes) such that uplink transmission or reception can be performed during an uplink subframe; quiet subframes (e.g., “Q” subframes) such that no transmission is performed during a quite subframe; and flexible subframes (e.g., “M” subframes) comprising one or more downlink subframes, one or more uplink subframes, one or more quite subframes, or a combination thereof.

In some implementations, exchanging the coordination information during the coordination subframe, process 800 may involve processor 712 performing a number of operations. For instance, process 800 may involve processor 712 transmitting first coordination information to at least the second node during one or more transmission opportunities according to a mutually hearable pattern during the coordination subframe. Additionally, process 800 may involve processor 712 receiving second coordination information from at least the second node during one or more reception opportunities according to the mutually hearable pattern during the coordination subframe. The mutually hearable pattern may be based on a device-to-device (D2D) communication standard (e.g., as used in LTE-based wireless communications).

In some implementations, a duration of each type of the plurality of types of subframes may be variable. Alternatively, the duration of each type of the plurality of types of subframes may be constant.

In some implementations, process 800 may additionally involve processor 712 adjusting transmission power during the flexible subframes. In adjusting the transmission power during the flexible subframes, process 800 may involve processor 712 performing either of the following: (1) decreasing the transmission power for downlink transmissions during the flexible subframes in an event that apparatus 710 is a base station (BS); or (2) increasing the transmission power during the flexible subframes in an event that apparatus 710 is a user equipment (UE). In some implementations, in decreasing the transmission power for downlink transmissions during the flexible subframes, process 800 may involve processor 712 decreasing the transmission power by an amount as a function of coupling losses among the nodes of the wireless network. In some implementations, in increasing the transmission power during the flexible subframes, process 800 may involve processor 712 increasing the transmission power by an amount as a function of coupling losses among the nodes of the wireless network.

In some implementations, process 800 may further involve processor 712 performing a number of operations. For instance, process 800 may involve processor 712 receiving, with apparatus 710 being a BS, a first CSI report for a downlink subframe from apparatus 720 as a UE. Moreover, process 800 may involve processor 712 receiving a second CSI report for a flexible subframe from apparatus 720. The first CSI report may be for the case that all top interfering cells that are aligned with a serving cell of apparatus 720. The second CSI report may be for the case that at least one top interfering cell that is not aligned with the serving cell of apparatus 720.

Alternatively, process 800 may further involve processor 712 performing a number of operations. For instance, process 800 may involve processor 712 transmitting, with apparatus 710 being a UE, a first CSI report for a downlink subframe to apparatus 720 as a BS. Additionally, process 800 may involve processor 712 transmitting a second CSI report for a flexible subframe to apparatus 720. The first CSI report may be for the case that all top interfering cells that are aligned in transmission direction with a serving cell of apparatus 710. The second CSI report may be for the case that at least one top interfering cell that is not aligned with the serving cell of apparatus 710.

In some implementations, process 800 may further involve processor 712 performing a number of operations. For instance, process 800 may involve processor 712 determining for which type of the plurality of types of subframes a CSI measurement is to be performed. Moreover, process 800 may involve processor 712 adjusting one or more aspects for the CSI measurement according to a result of the determination.

In some implementations, in adjusting the one or more aspects for the CSI measurement according to the result of the determination, process 800 may involve processor 712 transmitting, via transceiver 716, at full power for CSI measurement for channel state or interference responsive to a determination that the CSI measurement is to be performed during a downlink subframe of the plurality of types of subframes during which downlink transmission or reception can be performed.

In some implementations, in adjusting the one or more aspects for the CSI measurement according to the result of the determination, process 800 may involve processor 712 performing multiple CSI measurements for interference responsive to a determination that the CSI measurement is to be performed during a flexible subframe of the plurality of types of subframes comprising a combination of more than one of other types of subframes. Additionally, process 800 may involve processor 712 averaging results of the multiple CSI measurements for interference.

In some implementations, process 800 may further involve processor 712 performing a number of operations. For instance, process 800 may involve processor 712 broadcasting, with apparatus 710 being a BS, first clustering information related to a first cluster to which apparatus 710 belongs. Moreover, process 800 may involve processor 712 receiving, from at least one other node of the wireless network as another BS, second clustering information related to a second cluster to which the other node belongs. The first clustering information may indicate a first set of nodes of the wireless network in the first cluster. The second clustering information may indicate a second set of nodes of the wireless network in the second cluster.

In some implementations, process 800 may additionally involve processor 712 performing a number of operations. For instance, process 800 may involve processor 712 broadcasting first loading information related to desired UL and DL traffic split and experienced UL and DL traffic split with respect to a first cell to which apparatus 710 belongs. Additionally, process 800 may involve processor 712 receiving, from at least the one other node of the wireless network, second loading information related to desired UL and DL traffic split and experienced UL and DL traffic split with respect to a second cell to which the other node belongs.

In some implementations, process 800 may further involve processor 712 performing a number of operations. For instance, process 800 may involve processor 712 adopting a pattern of a combination of subframes of at least some of the plurality of types. Furthermore, process 800 may involve processor 712 coordinating transmission and reception operations within the first cell according to the adopted pattern.

In some implementations, process 800 may further involve processor 712 performing a number of operations. For instance, process 800 may involve processor 712 aggregating the desired UL and DL traffic split of at least the first cell and the second cell to provide a first result. Additionally, process 800 may involve processor 712 aggregating the experienced UL and DL traffic split of at least the first cell and the second cell to provide a second result. Moreover, process 800 may involve processor 712 comparing the first result with the second result. Furthermore, process 800 may involve processor 712 controlling transmission power based on the comparing. In aggregating, process 800 may involve processor 712 aggregating using an arithmetic method, a geometric method, or a combination thereof. In controlling the transmission power based on the comparing, process 800 may involve processor 712 decreasing a difference between a difference between BS transmission power and UE transmission power in the first cell responsive to the result of the comparing indicating downlink transmission is underserved. Additionally, process 800 may involve processor 712 increasing the difference between a difference between the BS transmission power and the UE transmission power in the first cell responsive to the result of the comparing indicating uplink transmission is underserved.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
exchanging, by a first node of a wireless network of a plurality of nodes, coordination information, which is related to transmissions of the nodes of the wireless network using time division duplex (TDD), with at least a second node of the wireless network; and
performing, by the first node, wireless communications with at least the second node based on the exchanged coordination information.

2. The method of claim 1, wherein the exchanging of the coordination information comprises:
defining a plurality of types of subframes for a corresponding plurality of activities, the plurality of types of subframes comprising coordination frames during each of which nodes of the network are allowed to exchange coordination information; and
exchanging the coordination information during a coordination subframe.

3. The method of claim 2, wherein the plurality of types of subframes further comprises:
downlink subframes such that downlink transmission or reception can be performed during a downlink subframe;
uplink subframes such that uplink transmission or reception can be performed during an uplink subframe;
quiet subframes such that no transmission is performed during a quite subframe; and
flexible subframes comprising one or more downlink subframes, one or more uplink subframes, one or more quite subframes, or a combination thereof.

4. The method of claim 2, wherein the exchanging of the coordination information during the coordination subframe comprises:
transmitting first coordination information to at least the second node during one or more transmission opportunities according to a mutually hearable pattern during the coordination subframe; and
receiving second coordination information from at least the second node during one or more reception opportunities according to the mutually hearable pattern during the coordination subframe,
wherein the mutually hearable pattern is based on a device-to-device (D2D) communication standard.

5. The method of claim 2, wherein a duration of each type of the plurality of types of subframes is variable.

6. The method of claim 3, further comprising:
adjusting, by the first node, transmission power during the flexible subframes.

7. The method of claim 6, wherein the adjusting of the transmission power during the flexible subframes comprises performing either of:
decreasing the transmission power for downlink transmissions during the flexible subframes in an event that the first node is a base station (BS); or
increasing the transmission power during the flexible subframes in an event that the first node is a user equipment (UE).

8. The method of claim 7, wherein the decreasing of the transmission power for downlink transmissions during the flexible subframes comprises decreasing the transmission power by an amount as a function of coupling losses among the nodes of the wireless network.

9. The method of claim 7, wherein the increasing of the transmission power during the flexible subframes comprises increasing the transmission power by an amount as a function of coupling losses among the nodes of the wireless network.

10. The method of claim 3, further comprising:
receiving, by the first node as a base station (BS), a first channel state information (CSI) report for a downlink subframe from the second node as a user equipment (UE); and
receiving, by the first node, a second CSI report for a flexible subframe from the second node.

11. The method of claim 3, further comprising:
transmitting, by the first node as a user equipment (UE), a first channel state information (CSI) report for a downlink subframe to the second node as a base station (BS); and
transmitting, by the first node, a second CSI report for a flexible subframe to the second node.

12. The method of claim 2, further comprising:
determining, by the first node, for which type of the plurality of types of subframes a channel state information (CSI) measurement is to be performed; and
adjusting, by the first node, one or more aspects for the CSI measurement according to a result of the determination.

13. The method of claim 12, wherein the adjusting of the one or more aspects for the CSI measurement according to the result of the determination comprises transmitting at full power for CSI measurement for channel state or interference responsive to a determination that the CSI measurement is to be performed during a downlink subframe of the plurality of types of subframes during which downlink transmission or reception can be performed.

14. The method of claim 12, wherein the adjusting of the one or more aspects for the CSI measurement according to the result of the determination comprises:
performing multiple CSI measurements for interference responsive to a determination that the CSI measurement is to be performed during a flexible subframe of the plurality of types of subframes comprising a combination of more than one of other types of subframes; and
averaging results of the multiple CSI measurements for interference.

15. The method of claim 3, further comprising:
broadcasting, by the first node as a base station (BS), first clustering information related to a first cluster to which the first node belongs; and
receiving, by the first node from at least one other node of the wireless network as another BS, second clustering information related to a second cluster to which the other node belongs,
wherein the first clustering information indicating a first set of nodes of the wireless network in the first cluster, and
wherein the second clustering information indicating a second set of nodes of the wireless network in the second cluster.

16. The method of claim 15, further comprising:
broadcasting, by the first node, first loading information related to desired uplink (UL) and downlink (DL) traffic split and experienced UL and DL traffic split with respect to a first cell to which the first node belongs; and
receiving, by the first node from at least the one other node of the wireless network, second loading information related to desired UL and DL traffic split and experienced UL and DL traffic split with respect to a second cell to which the other node belongs.

17. The method of claim 16, further comprising:
adopting, by the first node, a pattern of a combination of subframes of at least some of the plurality of types; and
coordinating, by the first node, transmission and reception operations within the first cell according to the adopted pattern.

18. The method of claim 16, further comprising:
aggregating, by the first node, the desired UL and DL traffic split of at least the first cell and the second cell to provide a first result;
aggregating, by the first node, the experienced UL and DL traffic split of at least the first cell and the second cell to provide a second result;
comparing, by the first node, the first result with the second result; and
controlling, by the first node, transmission power based on the comparing.

19. The method of claim 18, wherein the aggregating comprises aggregating using an arithmetic method, a geometric method, or a combination thereof.

20. The method of claim 18, wherein the controlling of the transmission power based on the comparing comprises:
decreasing a difference between a difference between BS transmission power and UE transmission power in the first cell responsive to the result of the comparing indicating downlink transmission is underserved; and
increasing the difference between a difference between the BS transmission power and the UE transmission power in the first cell responsive to the result of the comparing indicating uplink transmission is underserved.
